(19) United States
(12) Patent Application Publication
(10) Pub. No.: US 2007/0094831 A1
(43) Pub. Date: May 3, 2007

(54) All weather windshield wiper system

(76) Inventor: Alfred C. Huguley, Atlanta, GA (US)

Correspondence Address: JOHN L. JAMES, P.O. BOX 2025, MARIETTA, GA, 30061-2025, US

(21) Appl. No.: 11/262,899

(22) Filed: Oct. 31, 2005

(51) Int. Cl. B60S 1/28; B60S 1/38

(52) U.S. Cl. 15/250.4; 15/250.41; 15/250.361

(57) ABSTRACT

A windshield wiper system has multiple blades for clearing the windshield of rainwater, ice, snow, dust and debris. A pair of outer squeegee blades take care of rainwater while two pairs of inner blades remove ice, snow, dust and other debris. Each pair of inner blades is movable toward and from the windshield, one at a time, while the outer blades remain fixed. An inner blade moves from a normal position out of contact with the windshield to an extended position where it contacts the windshield lifting the fixed blades away from the windshield. Each movable blade is attached to an accordion linkage mechanism and operated from inside the vehicle via a cable.

### TECHNICAL FIELD OF THE INVENTION

This invention relates to a windshield wiper system for a vehicle or machine, and, more particularly, to a single windshield wiper system that can be used for all weather and environmental conditions.

### BACKGROUND OF THE INVENTION

Conventional windshield wiper systems employ a single wiper blade attached to a wiper arm assembly for clearing a windshield of water or condensation occurring during rain or fog. That single blade wiper works acceptably when used for clearing falling snow; however, it is ineffective for removing accumulated snow, ice and other debris. For example, when clearing a windshield of mud or dust, water is used causing the windshield to attract additional dust that is smeared on the windshield by the wiper blade. When clearing ice, the blade sometimes buckles or simply glides over patches of ice damaging the wiper blade material.

One approach to solving the problem of adequately clearing and cleaning the windshield uses a wiper with a blade that rotates to expose a different windshield contact material. When rain is the problem, a regular rubber or elastomeric blade is used, and when ice is the problem, the blade is rotated to expose a different, harder blade material. A problem with such a rotatable blade wiper system is that is requires the operator to manually rotate the wiper blade. Manual rotation must be accomplished from outside the vehicle requiring the operator to exit the vehicle which is not always possible or even practical. Accordingly, it will be appreciated that it would be highly desirable to have a windshield wiper system that can be easily used in any weather or environmental condition from inside the vehicle or machine.

### SUMMARY OF THE INVENTION

The present invention is directed to overcoming one or more of the problems set forth above. Briefly summarized, according to one aspect of the present the invention, a windshield wiper system comprises a wiper arm; a base member pivotally attached to the wiper arm; a first wiper blade assembly having a first wiper blade and being attached to the base member; a linkage assembly attached to the base member and positioned adjacent the first wiper blade assembly; a second wiper blade assembly having a second wiper blade attached to the linkage assembly; and means for extending and retracting the linkage assembly.

The linkage assembly has an upper connecting member, a lower connecting member spaced from the upper connecting member, and one or more intermediate connecting members pivotally connected to the upper and lower connecting members. The upper, lower and intermediate connecting members operate like a bellows moving the lower connecting member toward and from the upper connecting member and thereby moving the second wiper blade toward and from the windshield. A cable operated from inside the vehicle extends and retracts the linkage assembly to move the second wiper blade toward and from the windshield.

According to another aspect of the invention, a windshield wiper system comprises a wiper arm; a base member having first and second edge portions and being pivotally attached to the wiper arm; a first wiper blade assembly having a first wiper blade and being attached to the first edge portion of the base member; a second wiper blade assembly having a second wiper blade and being attached to the second edge portion of the base member; a linkage assembly attached to the base member and positioned intermediate the first and second wiper blade assemblies; an intermediate wiper blade assembly having a third wiper blade attached to the linkage assembly; and means for extending and retracting the linkage assembly.

The windshield wiper system has multiple blades for clearing the windshield of rainwater, ice, snow, dust and debris. A pair of outer elastomeric squeegee blades remove rainwater while two pairs of inner blades remove ice, snow, dust and other debris. A rigid blade removes ice while a spongy blade takes care of snow, dust and debris. Each pair of inner blades is movable toward and from the windshield, one at a time, while the outer blades remain fixed. An inner blade moves from a normal position out of contact with the windshield to an extended position where it contacts the windshield lifting the fixed exterior blades away from the windshield. Each movable blade is attached to an accordion linkage mechanism and operated from inside the by the driver vehicle via a cable. There is no longer a need to have only one blade option or the need to stop the vehicle to adapt the wipers to environmental conditions.

These and other aspects, objects, features and advantages of the present invention will be more clearly understood and appreciated from a review of the following detailed description of the preferred embodiments and appended claims, and by reference to the accompanying drawings

### BRIEF DESCRIPTION OF THE DRAWINGS

FIG. 1 is a diagrammatical view of a preferred embodiment of a windshield wiper system having multiple blades according to the present invention.

FIG. 2 is a diagrammatic sectional view of the wiper taken along line 2-2 of FIG. 1 further illustrating multiple blades.

FIG. 3 is a diagrammatic sectional view similar to FIG. 1 but illustrating a retractable blade extended to contact a windshield.

FIGS. 4-5 are diagrams illustrating operation of the extension linkage to raise and lower a wiper blade.

FIG. 6 is diagrammatic exploded view of a squeegee wiper blade.

FIG. 7 is a perspective view of an ice scraper wiper blade.

FIG. 8 is an end view of the ice scraper wiper blade of FIG. 7.

### DETAILED DESCRIPTION OF THE PREFERRED EMBODIMENTS

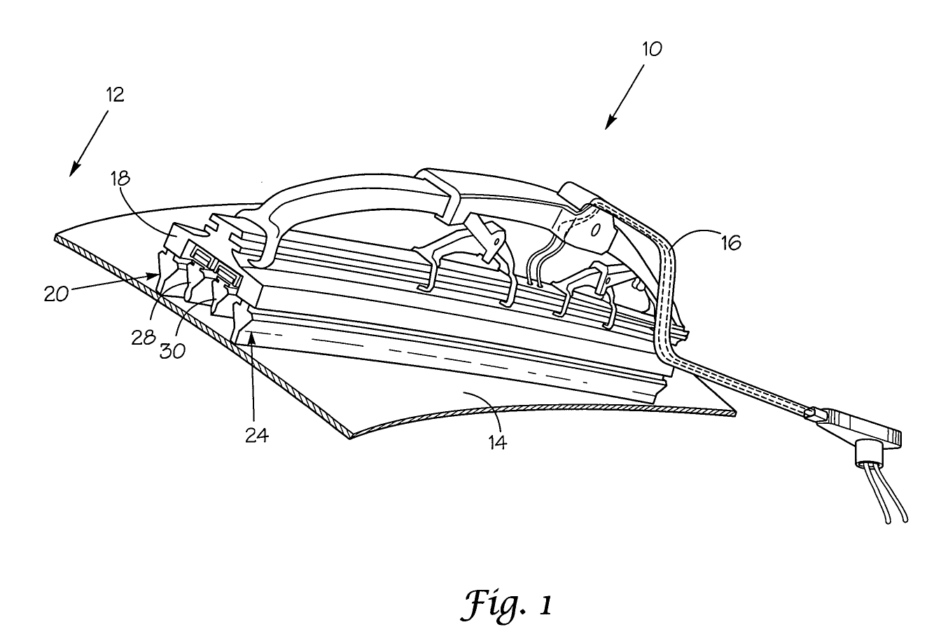

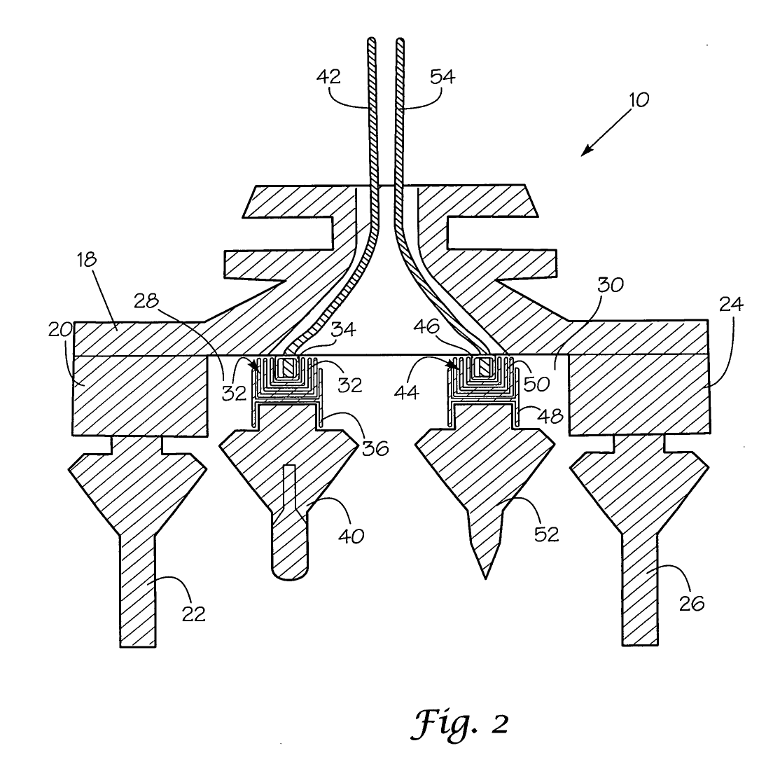

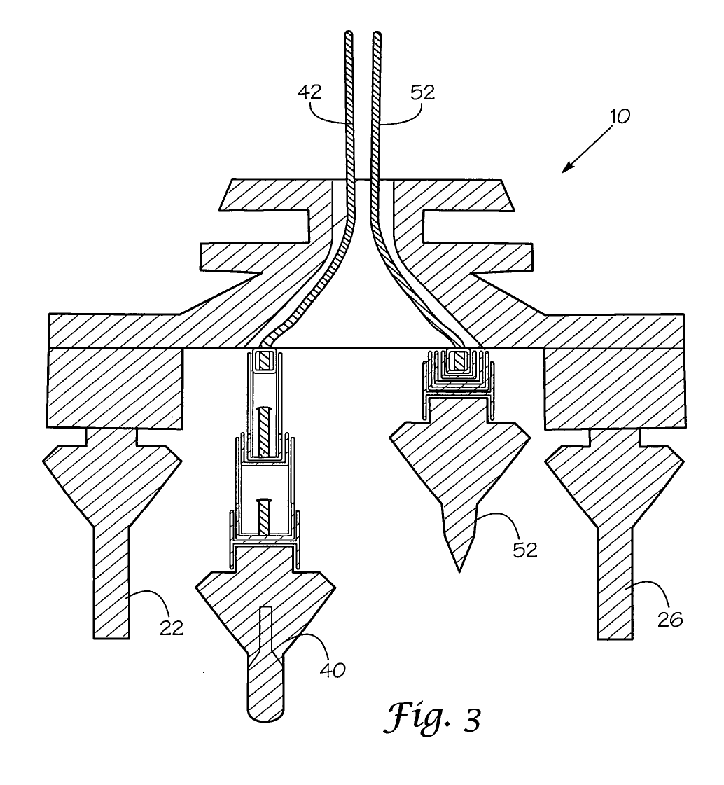

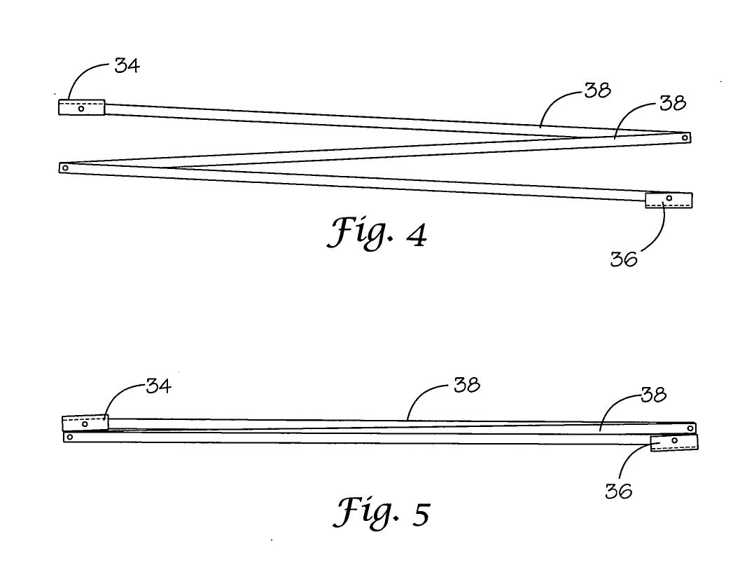

Referring to FIGS. 1-2, a windshield wiper system 10 for a machine or vehicle 12 clears the windshield 14 of rainwater, ice, snow, dust, mud and debris. Clearing is accomplished by using a plurality of wiper blades on each wiper arm 16 and lowering an appropriate blade for clearing ice, snow, dust, mud and debris while the blade for rainwater is moved out of contact with the windshield 14.

The system 10 includes a base member 18 of metal, plastic or other material that has first and second edge portions and is pivotally attached to wiper arm 16. An exterior or first wiper blade assembly 20 has a first conventional rubber or elastomeric wiper blade 22, and is attached to the first edge portion of base member 18. An exterior or second wiper blade assembly 24 has a second conventional rubber or elastomeric second wiper blade 26, and is attached to the second edge portion of base member 18.

The present invention differs from conventional wiper blade assemblies by providing at least a first, and preferably a second, interior or intermediate wiper blade assembly 28, 30 positioned between exterior wiper blade assemblies 20, 24.

A first linkage assembly 32 is attached to base member 18 and is positioned intermediate the first and second wiper blade assemblies 20, 24. First linkage assembly 32 comprises an upper connecting member 34, a lower connecting member 36, and at least one intermediate connecting member 38 pivotally connected to the upper and lower connecting members 34, 36. The upper, lower and intermediate connecting members form an extension device that operate like an accordion or bellows moving lower connecting member 36 toward and from upper connecting member 34 which is fastened to base member 18.

Intermediate wiper blade assembly 28 has a wiper blade 40 attached to the lower connecting member 36 of the linkage assembly 32. Also attached to the lower connecting member 36 of the linkage assembly 32 is a cable 42. The other end of cable 42 terminates inside the vehicle where it attaches to a knob, panel or other lever for operation. Cable 42 provides a means for extending and retracting linkage assembly 32 and thereby wiper blade 40.

A second linkage assembly 44 is attached to base member 18 and is positioned intermediate the first and second wiper blade assemblies 20, 24 adjacent intermediate wiper blade assembly 28. Linkage assembly 44 comprises an upper connecting member 46, a lower connecting member 48, and at least one intermediate connecting member 50 pivotally connected to the upper and lower connecting members 46, 48. The upper, lower and intermediate connecting members form an extension mechanism that operates like an accordion or bellows moving lower connecting member 48 toward and from upper connecting member 46 which is fastened to base member 18.

Intermediate wiper blade assembly 30 has a wiper blade 52 attached to the lower connecting member 48 of the linkage assembly 44. Also attached to the lower connecting member 48 of the linkage assembly 44 is a cable 54. The other end of cable 54 terminates inside the vehicle where it attaches to a knob, panel or other lever for operation. Cable 54 provides a means for extending and retracting linkage assembly 32 and thereby wiper blade 40.

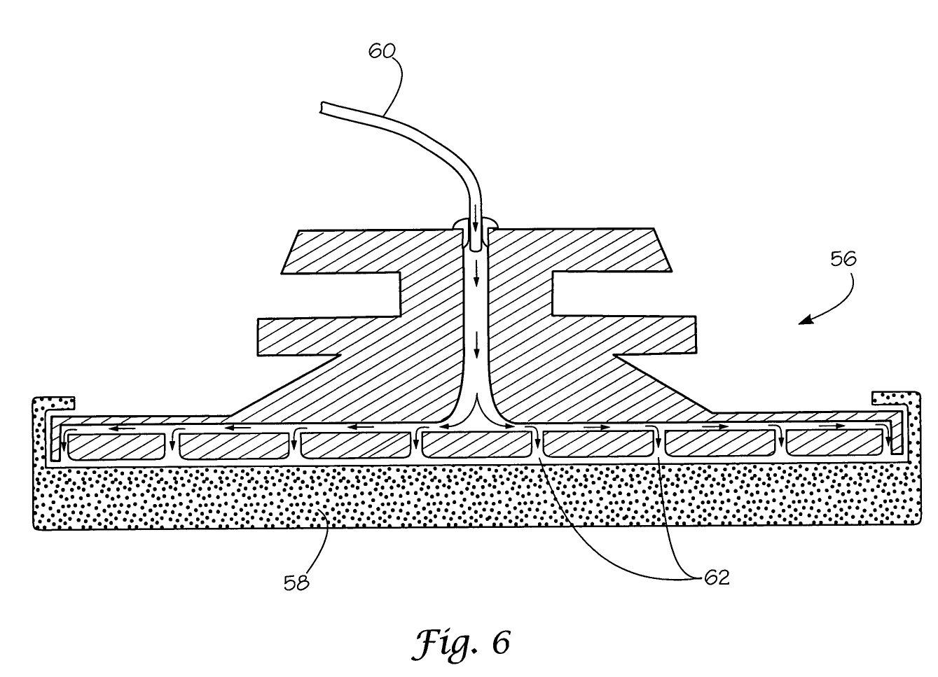

FIG. 6 illustrates a squeegee wiper blade 56 that has a spongy cover member 58 for absorbing and then dispersing cleaning fluid. Water or cleaning fluid is routed from a fluid reservoir in the vehicle through tubing 60 and a plurality of openings 62 to spongy cover 58. Tubing 60 preferably terminates in a fluid holding chamber prior to dispersal to the spongy cover 58.

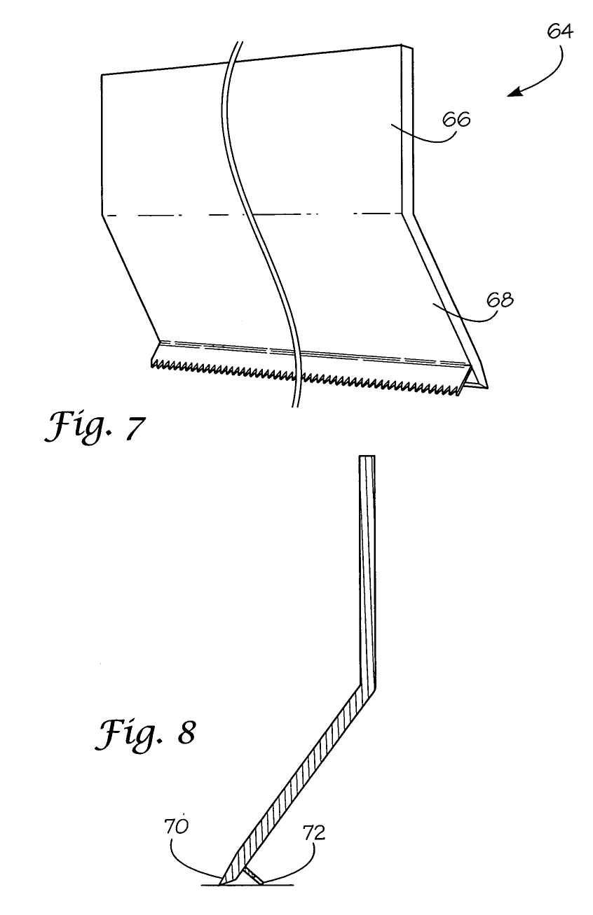

FIGS. 7-8 illustrate an intermediate blade 64 for removing ice. Blade 64 has an upper attaching portion 66 and a lower working portion 68. Working portion 68 is displaced from upper portion 66 at an angle of about forty-five degrees. A distal portion of lower portion 68 is preferably bifurcated forming a scraper 70 and serrations or teeth 72. Teeth 72 may be shallow, fine and narrow like the teeth of a crosscut saw blade as illustrated or may be squarer like the teeth on dental molding. On a forward (or reverse) pass of the wiper, scraper 70 removes ice by scraping loose ice off the windshield. On a reverse (or forward) pass of the wiper, teeth 72 break the ice so that it can be removed by scraping on the next pass.

It can now be appreciated that a windshield wiper system for a machine or a vehicle has been presented that changes wiper blades according to the type of material to be removed from the windshield. Normally, the exterior wiper blades are common squeegee blades constructed of rubber or elastomeric material for moving water. Intermediate wiper blade 40 can be used for snow, dust and mud. Blade 40 may have a deformable surface for contacting the windshield and hugging to it so that it actually removes material rather than simply gliding over the material. A spongy material has the advantage of absorbing moisture that is helpful where there is dust or mud. When a spongy material is used, the cleaning fluid that is normally lost is captured for cleaning. Intermediate blade 52 removes ice. It is formed of a hard plastic material or metal with a pointed working surface so that it is useful for scrapping ice from the windshield and pushing sheets of melting ice off the windshield. Either or both intermediate wiper blades may be used in a wiper assembly, although only one of the blades contacts the windshield at a time.

While the invention has been described with particular reference to the preferred embodiments, it will be understood by those skilled in the art that various changes may be made and equivalents may be substituted for elements of the preferred embodiments without departing from invention. For example, instead of operating the cables by manually pulling a knob or lever, a cable may be connected to a motor operated by a push button.

As is evident from the foregoing description, certain aspects of the invention are not limited to the particular details of the examples illustrated, and it is therefore contemplated that other modifications and applications will occur to those skilled in the art. For example, a wiper blade for scraping ice may have a sharp edge on a front working surface and a serrated rear working surface like a manual ice scraper. It is accordingly intended that the claims shall cover all such modifications and applications as do not depart from the true spirit and scope of the invention.

### ELEMENT LIST

10 windshield wiper system
12 machine or vehicle
14 windshield
16 wiper arm
18 base member
20 exterior or first wiper blade assembly
22 wiper blade
24 exterior or second wiper blade assembly
26 wiper blade
28 interior or intermediate wiper blade assembly
30 interior or intermediate wiper blade assembly
32 linkage assembly
34 upper connecting member
36 lower connecting member
38 intermediate connecting member
40 wiper blade
42 cable
44 linkage assembly
46 upper connecting member
48 lower connecting member
50 intermediate connecting members
52 wiper blade
54 cable
56 squeegee wiper blade
58 spongy cover member
60 tubing
62 plurality of openings
64 intermediate wiper blade
66 upper attaching portion
68 lower working portion
70 scraper
72 teeth

What is clamed is:

1. A windshield wiper system, comprising:
a wiper arm;
a base member pivotally attached to said wiper arm;
a first wiper blade assembly having a first wiper blade and being attached to said base member;
a linkage assembly attached to said base member and positioned adjacent said first wiper blade assembly;
a second wiper blade assembly having a second wiper blade attached to said linkage assembly; and
means for extending and retracting said linkage assembly.

2. A windshield wiper system, as set forth in claim 1, wherein said linkage assembly comprises:
an upper connecting member;
a lower connecting member spaced from said upper connecting member;
at least one intermediate connecting member pivotally connected to said upper connecting member and said lower connecting member; said upper, lower and intermediate connecting members operating like a bellows moving said lower connecting member toward and from said upper connecting member.

3. A windshield wiper system, as set forth in claim 2, wherein said means for extending and retracting said linkage assembly includes a cable attached to said lower connecting member.

4. A windshield wiper system, comprising:
a wiper arm;
a base member having first and second edge portions and being pivotally attached to said wiper arm;
a first wiper blade assembly having a first wiper blade and being attached to said first edge portion of said base member;
a second wiper blade assembly having a second wiper blade and being attached to said second edge portion of said base member;
a first linkage assembly attached to said base member and positioned intermediate said first and second wiper blade assemblies;
a first intermediate wiper blade assembly having a third wiper blade attached to said first linkage assembly; and
first means for extending and retracting said first linkage assembly.

5. A windshield wiper system, as set forth in claim 4, wherein said first and third wiper blades are squeegee blades.

6. A windshield wiper system, as set forth in claim 4, wherein said third wiper blade has a spongy contact surface.

7. A windshield wiper system, as set forth in claim 4, wherein said third wiper blade has a deformable contact surface.

8. A windshield wiper system, as set forth in claim 4, wherein said third wiper blade has a thin rigid contact surface.

9. A windshield wiper system, as set forth in claim 4, wherein said first linkage assembly comprises an upper connecting member, a lower connecting member, and at least one intermediate connecting member pivotally connected to said upper and lower connecting members.

10. A windshield wiper system, as set forth in claim 9, wherein said upper, lower and intermediate connecting members operate like a bellows moving said lower connecting member toward and from said upper connecting member.

11. A windshield wiper system, as set forth in claim 10, wherein said means for extending and retracting said first linkage assembly includes a first cable attached to said lower connecting member.

12. A windshield wiper system, as set forth in claim 10, including:
a second linkage assembly attached to said base member and positioned intermediate said first linkage assembly and said second wiper blade assembly;
a second intermediate wiper blade assembly having a fourth wiper blade attached to said second linkage assembly; and
second means for extending and retracting said second linkage assembly.

13. A windshield wiper system, comprising:
a wiper arm;
a base member having first and second edge portions and being pivotally attached to said wiper arm;
a first wiper blade assembly having a first wiper blade and being attached to said first edge portion of said base member;
a second wiper blade assembly having a second wiper blade and being attached to said second edge portion of said base member;
a first linkage assembly attached to said base member and positioned intermediate said first and second wiper blade assemblies;
a first intermediate wiper blade assembly having a third wiper blade attached to said first linkage assembly; and
first means for extending and retracting said first linkage assembly;
a second linkage assembly attached to said base member and positioned intermediate said first linkage assembly and said second wiper blade assembly;
a second intermediate wiper blade assembly having a fourth wiper blade attached to said second linkage assembly; and
second means for extending and retracting said second linkage assembly.

14. A windshield wiper system, as set forth in claim 13, wherein said first and third wiper blades are squeegee blades.

15. A windshield wiper system, as set forth in claim 13, wherein said third wiper blade has a spongy contact surface and said fourth wiper blade has a rigid contact surface.

16. A windshield wiper system, as set forth in claim 13, wherein said third wiper blade has a deformable contact surface and said fourth wiper blade has a rigid contact surface.

17. A windshield wiper system, as set forth in claim 13, wherein said third wiper blade has a deformable contact surface and said fourth wiper blade has a scraping contact surface.

18. A windshield wiper system, as set forth in claim 13, wherein;
said first linkage assembly comprises a first upper connecting member, a first lower connecting member, and at least one first intermediate connecting member pivotally connected to said first upper and lower connecting members; and
said second linkage assembly comprises a second upper connecting member, a second lower connecting member, and at least one second intermediate connecting member pivotally connected to said second upper and lower connecting members.

19. A windshield wiper system, as set forth in claim 18 wherein:
said first upper, lower and intermediate connecting members operate like a bellows moving said first lower connecting member toward and from said first upper connecting member; and
said second upper, lower and intermediate connecting members operate like a bellows moving said second lower connecting member toward and from said second upper connecting member.

20. A windshield wiper system, as set forth in claim 19, wherein:
said first means for extending and retracting said first linkage assembly includes a first cable attached to said first lower connecting member; and
said second means for extending and retracting said second linkage assembly includes a second cable attached to said second lower connecting member.
